(19) United States
(12) Patent Application Publication
(10) Pub. No.: US 2019/0045922 A1
(43) Pub. Date: Feb. 14, 2019

(54) MULTI-PURPOSE ROD RACK

(71) Applicant: J. Brent JACOBS, Breaux Bridge, LA (US)

(72) Inventor: J. Brent JACOBS, Breaux Bridge, LA (US)

(21) Appl. No.: 15/676,516

(22) Filed: Aug. 14, 2017

(51) Int. Cl. A47B 81/00; A01K 97/10

(52) U.S. Cl. CPC A47B 81/005; A01K 97/10

(57) ABSTRACT

A rack apparatus for holding a plurality of fishing rods. Each fishing rod has an elongate rod with a handle, a tip portion, and a reel. The rack apparatus includes an elongate member having a base segment and first and second upturned end segments. The first upturned end segment has a plurality of open-ended slots and the second upturned end segment has a plurality of openings, with the same number of slots as openings. The openings are arranged and designed to receive the rod tip portion and the open-ended slots are arranged and designed to receive the rod handle. A strap is arranged and designed to circumvent the plurality of fishing rods and releasably secure the fishing rods to the elongate member. A handle for transporting the rack apparatus is connected to the base segment and there is at least one fastener for releasably securing the elongate member to a surface of a boat.

### CROSS-REFERENCE TO RELATED APPLICATIONS

Not applicable.

### BACKGROUND OF THE INVENTION

### 1. Field of the Invention

The present invention relates generally to fishing rod holders, and more specifically relates to fishing rod holders for use on boat and use for rod storage and transport.

### 2. Description of the Related Art

Fishing is a very popular sport and something that most everyone has done at some point during their lifetime. It's not complicated to learn how to fish, but for the serious angler the science of fishing has developed significantly. Anglers today select their fishing rods, reels and line for specific expeditions to fish for certain types and weights of fish.

Manufacturers of fishing rods typically list the following characteristics to describe fishing rods: power, action, weight, shape, number of pieces, length, stiffness, recovery, sensitivity, brittleness and balance. Rods have a specified line weight range that the rod can support. A rod may also be described by the weight of the fishing lure or hook that the rod is designed to support.

There are also different types of reels and fishing line weights. Thus, one rod and reel combination does not suit all purposes for the serious angler. Furthermore, one rod and reel combination typically doesn't suffice for an angler on a one day fishing trip because we don't know what will be biting, the type of bait the fish will be biting on, the size of the fish that are biting, etc. All of which is to point out that an angler today typically goes out fishing from a boat with multiple rod and reel combinations.

Even for a specific type of fishing, such as bass fishing, the rod, reel and line may be matched to the type of bait chosen. In other words, it is commonplace for an angler to take multiple fishing rod and reel combinations on a boat when fishing for a particular type of fish. Oftentimes space on boats is rather limited, especially after loading the boat with tackle, multiple rods and reels, a cooler, net, etc.

A bass boat is a small boat that is designed and equipped primarily for bass fishing or fishing for other panfish, usually in freshwater such as lakes, rivers and streams. The modern bass boat features swivel chairs that permit the angler to cast to any position around the boat, storage bins for fishing tackle and equipment such as rods and lures, and a live well with recirculating water where caught fish may be stored and kept alive. Bass boats are usually propelled by two means: an outboard motor, which moves the boat swiftly from place to place; and a trolling motor, which moves the boat at a slow pace through an area where the angler is fishing. Should those motors fail, bass boats are small enough to be propelled by oars in an emergency.

Anglers want to spend their time fishing when on their boats—not wasting a lot of time changing out tackle, organizing gear on the deck, untangling fishing lines, etc. It is desirable to have a rod holder for holding a plurality of rod and reels on the boat when not in use. It is further desirable that the rod holder be compact and hold the rods securely while also making the rods easily accessible for use and storage.

Anglers also invest a significant amount of money in their rods and reels. For example, a serious angler may modestly spend a few hundred dollars for a bass fishing rod and reel and can easily spend several hundred dollars for the higher end product range. The angler often takes 3 or 4 rods/reels on the boat and some anglers take even more with them.

Due to the value of the rods/reels, most anglers prefer not to leave the rods/reels on a boat unattended at the dock or on a trailer because it may invite theft. It is desirable to be able to transport the plurality of rods/reels to and from the boat in an organized, easy and efficient manner. It is additionally desirable to be able to store the plurality of rods/reels within a building in a manner that keeps them organized and tangle-free.

### SUMMARY OF THE INVENTION

A multi-purpose rack apparatus for holding a plurality of fishing rods. Each fishing rod has an elongate rod with a handle, a tip portion, and a reel. The rack apparatus includes an elongate member having a base segment and first and second upturned end segments. The first upturned end segment has a plurality of open-ended slots and the second upturned end segment has a plurality of openings, with the same number of slots as openings. The openings are arranged and designed to receive the rod tip portion and the open-ended slots are arranged and designed to receive the rod handle. A strap is arranged and designed to circumvent the plurality of fishing rods and releasably secure the fishing rods to the elongate member. A handle for transporting the rack apparatus is connected to the base segment and there is at least one fastener for releasably securing the elongate member to a surface of a boat.

### BRIEF DESCRIPTION OF THE SEVERAL VIEWS OF THE DRAWINGS

The invention is better understood by reading the detailed description of embodiments which follows and by examining the accompanying drawings, in which:

FIG. 1 is a perspective view of the multi-purpose rod rack apparatus according to a preferred embodiment of the invention;

FIG. 2 is a perspective view of the multi-purpose rod rack apparatus according to a second preferred embodiment of the invention;

FIG. 3 is an elevation view of an upturned end portion of an alternate embodiment;

FIG. 4 is an enlarged perspective view of a fastener; and

FIG. 5 is a perspective view of the multi-purpose rod rack apparatus holding four fishing rods.

### DESCRIPTION OF THE PREFERRED EMBODIMENTS

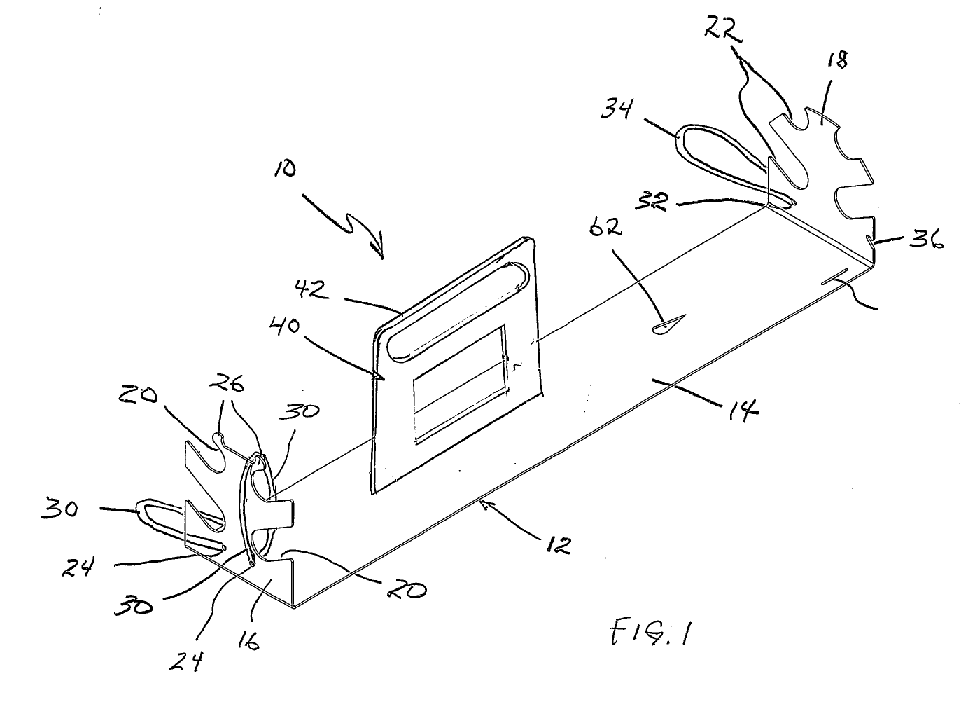

FIG. 1 is a perspective view of a preferred embodiment of the multi-purpose rod rack apparatus, generally designated as 10, for holding a plurality of fishing rods. FIG. 5 shows the multi-purpose rod rack apparatus 10 holding four fishing rods 100. Each fishing rod 100 has an elongate rod 102 with a handle 104, a tip portion 106, and a reel 108.

In the preferred embodiment of FIG. 1, the rack apparatus 10 comprises an elongate member 12 having a base segment 14 and first and second upturned end segments 16 and 18, respectively. The elongate member 12 is relatively stiff and preferably made of aluminum. The base segment 14 preferably has a length in the range of 30 to 40 inches, more preferably approximately 35 inches. The upturned end segments 16, 18 of a rack apparatus 10 capable of holding four fishing rods may have a height in the range of 6 to 7 inches and a width in the range of 6 to 7 inches, and more preferably have a height and width of approximately 6.5 inches. It is to be understood that the present invention is not limited to these dimensions.

The first upturned end segment 16 has a plurality of open-ended slots 20 and the second upturned end segment 18 has a plurality of openings 22. In the embodiment shown in FIG. 1, there are four open-ended slots 20 and four openings 22. Preferably, the number of slots 20 will be the same as the number of openings 22. Preferably, each slot 20 will have a corresponding opening 22 in substantially axial alignment. The openings 22 are arranged and designed to receive the rod tip portion 106 and the open-ended slots 20 are arranged and designed to receive the rod handle 104 as shown in FIG. 5. Preferably, the reels 108 are located between the upturned end segments 16 and 18 and substantially adjacent to the first upturned end segment 16.

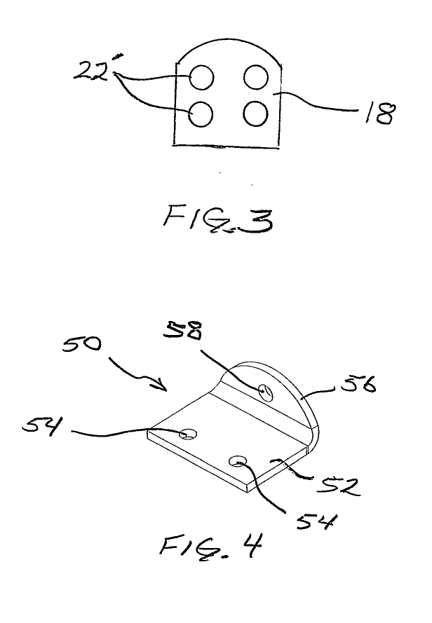

As shown in FIG. 1, the plurality of openings 22 are open-ended openings. This allows an upper portion of the elongate rod 102 near the tip end 106 to be positioned into or removed from the opening 22 in a generally lateral direction via the open end of the opening 22. In an alternate embodiment shown in FIG. 3, the plurality of openings 22 may be substantially circular openings 22′. In this alternate embodiment, the rod tip end 106 must be inserted and removed axially through the opening 22′.

At least one strap 30 is arranged and designed to circumvent the plurality of fishing rods 100 and releasably secure the fishing rods 100 to the elongate member 12. In the preferred embodiment of FIG. 1, a pair of straps 30 are shown attached to the first upturned end segment 16. The first upturned end segment 16 includes a pair of small holes 24 located below the lower open-ended slots 20. Each strap 30 is threaded through one of the small holes 24 and then the strap ends are joined to form a loop. Preferably, the first upturned end segment 16 includes a pair of upper teats 26 located above the upper open-ended slots 20. Preferably, the straps 30 have elasticity and the loops are sized such that when the fishing rods 100 are in the open-ended slots 20, the loops extend around the outward portion of the fishing rods 100 and stretch to be extended over the upper teats 26 as shown in FIG. 5. The teats 26 maintain the stretched loop strap 30 in place to secure the fishing rods 100 to the first upturned end segment 16. With two straps 30, the angler can release of one strap from one teat 26 allowing removal of two rods while two other rods remain secured.

It is to be understood that the strap or straps 30 could take on many different forms. For example, the strap or straps 30 could have free ends that are tied together or have adjustable fasteners to cinch the strap snugly against the teat. One strap 30 could extend around all of the fishing rods 100 and be tied or drawn snug. In one or more of the variations, the strap(s) 30 may not need to be stretchable but instead merely able to be drawn taut.

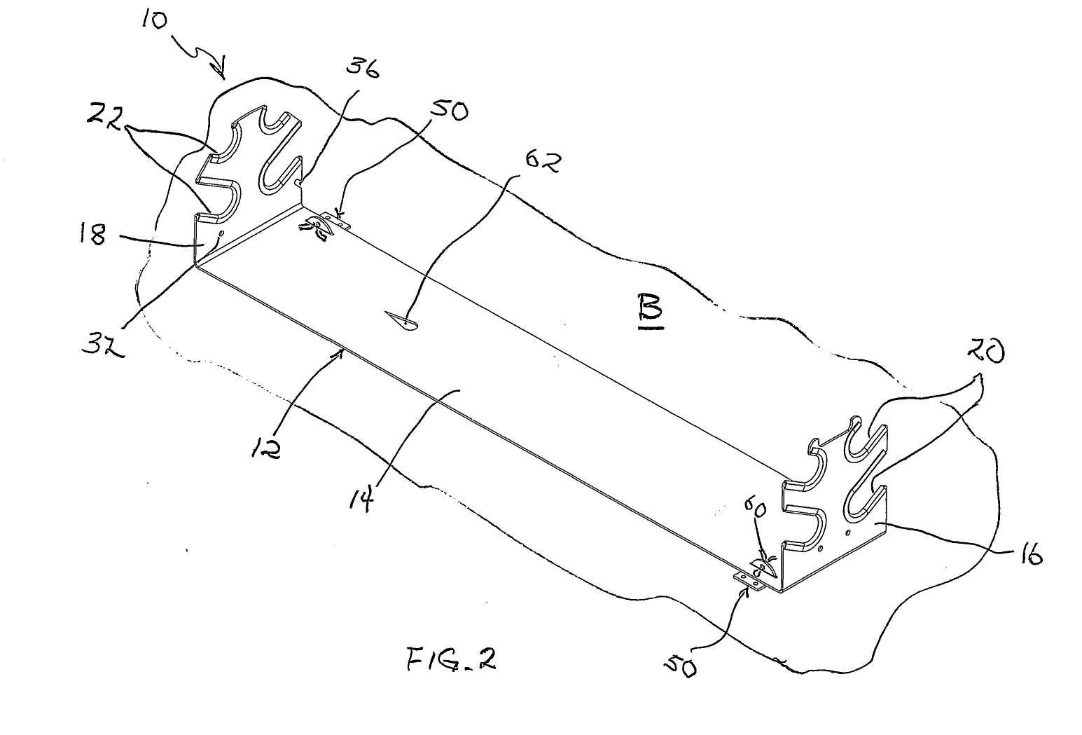

In the preferred embodiments of FIGS. 1 and 2, the plurality of openings 22 in the second upturned end segment 18 are open-ended openings. As a result, it is desirable to have a means of securing the upper tip portions 106 of the fishing rod 100 to the second upturned end segment 18. The second upturned end segment 18 includes a small hole 32 located below a lower open-ended opening 22. A cord 34 is threaded through the small hole 32 and then the cord ends are joined to form a loop. Preferably, the second upturned end segment 18 has a catch 36 located below the other lower open-ended opening 22 as shown in FIGS. 1 and 2. With reference to FIG. 5, preferably the cord 34 has elasticity, and/or can be drawn taut, and the loop is sized such that when the elongate rods 102 are in the open-ended openings 22, the loop extends around the outward portion of the elongate rods 102 and stretches to be extended in the catch 36. The catch 36 maintains the stretched loop cord 34 in place to secure the fishing rods 100 to the second upturned end segment 18.

Referring to FIG. 1, preferably a rack handle 40 is connected to the base segment 14. The rack handle 40 has a gripping portion 42 and is arranged and designed for transporting the rack apparatus 10 in a generally horizontal position. The rack handle 40 is preferably closer to the first upturned end segment 16 than to the second upturned end segment 18 to more evenly distribute the weight since the rod handles 104 and reels 108 are positioned at or adjacent the first upturned end segment 16. The rack handle 40 extends from the base segment 14 in the same direction as the first and second upturned end segments 16, 18. Preferably, the rack handle 40 has a height greater than the upturned end segments 16, 18, or at least greater than fishing rods 100 positioned in the upper slots 20 and openings 22. As an example, the handle may have a height of 7.5 to 8 inches for the rack apparatus 10 capable of holding four rods 100.

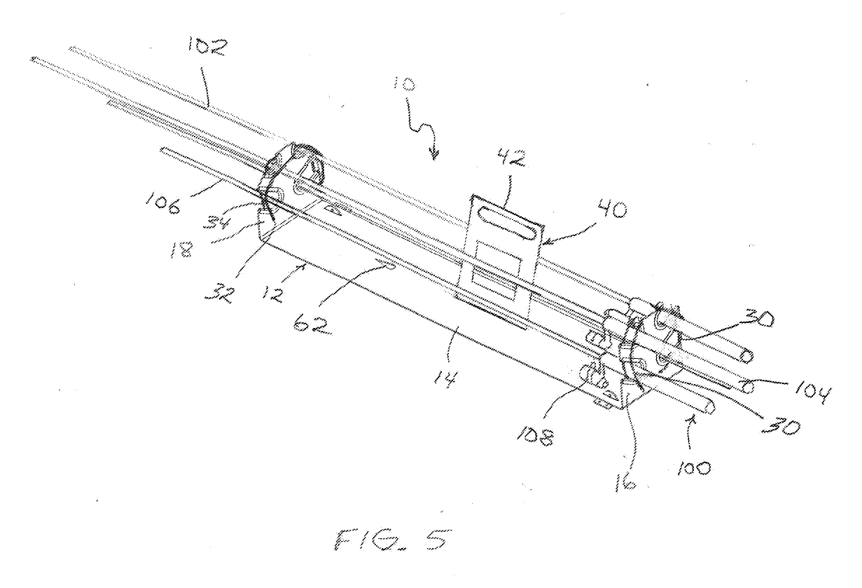

Preferably, there is at least one fastener 50 for releasably securing the elongate member 12 to a surface of a boat B (FIG. 2). In the preferred embodiments, a pair of fasteners 50 are used to secure the rack apparatus 10 to the boat B. Referring to FIGS. 2 and 4, the fasteners 50 comprise a bracket, generally L-shaped, which includes a base 52 having at least one hole 54 for securing the bracket to the surface of the boat B, and an upright 56 with a locking orifice 58. The base segment 14 of the elongate member 12 includes a pair of slits 28 through which the locking orifice 58 and a portion of the upright 56 of the bracket 50 extend. Pins and/or locks 60 may extend through the locking orifice 58 to secure the elongate member 12 to the boat B as shown in FIG. 2.

Preferably, the base segment 14 of the elongate member 12 includes an aperture 62 arranged and designed for hanging the elongate member 12 in a substantially vertical position. Preferably, the aperture 62 is closer to the second upturned end segment 18 than to the first upturned end segment 16. The rack apparatus 10 equipped with fishing rods 100 may be hung vertically from a nail or other hanger extending through the aperture 62. This allows the rack apparatus 10 to provide compact organization for storing the fishing rods 100 in a house, garage, storage unit or other structure.

Although not shown in FIG. 2, it is to be understood that various features described with respect to the embodiment of FIG. 1 may also apply to the embodiment of FIG. 2. The main difference of the embodiments of FIGS. 1 and 2 is that the peripheral edges of the open-ended slots 20 and openings 22 are covered with an elastomeric or rubber material to prevent scratches and other damage to the fishing rods 100 when inserting, removing, travelling, transporting or storing the fishing rods 100 in the rack apparatus 10.

The multi-purpose rod rack apparatus 10 provides anglers with a multi-functional rack for storing, transporting and boat fishing with a plurality of fishing rods 100. The rack apparatus 10 is compact and lightweight and keeps the rods 100 with attached bait and hooks from becoming tangled with each other. During storage, the rack apparatus 10 can be used to store the rods 100 in horizontal orientation by positioning the base segment 14 on a horizontal surface or support, or can be stored vertically by hanging the rack apparatus 10 via the aperture 62. The rack apparatus 10 with a plurality of rods 100 may be carried to and from the boat, hotel, storage unit, etc. via the carrying handle 40. Additionally, the rack apparatus 10 is easily and removably attached to a surface of the boat with a small bracket mounted to the boat. Each of the fishing rods 100 is easily and quickly accessible to the angler while fishing and secure when not being used by the angler.

While the invention has been described in detail above with reference to specific embodiments, it will be understood that modifications and alterations in the embodiments disclosed may be made by those practiced in the art without departing from the spirit and scope of the invention. All such modifications and alterations are intended to be covered. In addition, all publications cited herein are indicative of the level of skill in the art and are hereby incorporated by reference in their entirety as if each had been individually incorporated by reference and fully set forth.

1. A rack apparatus for holding a plurality of fishing rods, each fishing rod having an elongate rod with a handle and a tip portion, and a reel, the rack apparatus comprising:
an elongate member having a base segment and first and second upturned end segments, the first upturned end segment having a plurality of open-ended slots and a pair of upper teats extending upwardly from a freestanding end of the first upturned end segment, the second upturned end segment having a plurality of openings;
a pair of straps, each strap having a strap first portion connected to the first upturned end segment at a location below the plurality of open-ended slots and having a strap second portion arranged and designed to releasably attach to one of the pair of upwardly extending teats.

2. The rack apparatus of claim 1, further comprising a rack handle connected directly to the base segment, the rack handle arranged and designed for transporting the rack apparatus.

3. The rack apparatus of claim 2, wherein the rack handle is closer to the first upturned end segment than to the second upturned end segment.

4. The rack apparatus of claim 3, wherein the rack handle extends from the base segment in the same direction as the first and second upturned end segments, and the rack handle has a height greater than the upturned end segments.

5. The rack apparatus of 1, further comprising at least one fastener for releasably securing the elongate member to a surface of a boat.

6. The rack apparatus of claim 1, wherein the base segment includes an aperture on a central longitudinal axis of the base segment, the aperture arranged and designed for hanging the base segment in a substantially vertical position such that the second upturned end segment is vertically above the first upturned end segment, the aperture being closer to the second upturned end segment than to the first upturned end segment.

7. The rack apparatus of claim 1, wherein the plurality of openings in the second upturned end segment are substantially circular holes arranged and designed to receive the rod tip portion and the plurality of open-ended slots are arranged and designed to receive the rod handle.

8. The rack apparatus of claim 7, further comprising:
a rack handle connected to the base segment, the rack handle extending from the base segment on a central longitudinal axis of the base segment, the rack handle arranged and designed for transporting the rack apparatus; and
at least one fastener for releasably securing the elongate member to a surface of a boat.

9. The rack apparatus of claim 8, wherein the base segment includes an aperture arranged and designed for hanging the elongate member in a substantially vertical position, the aperture being closer to the second upturned end segment than to the first upturned end segment.

10. The rack apparatus of claim 1, further comprising:
a cord having a cord first portion connected to the second upturned end segment and having a cord second portion,
wherein the second upturned end segment has a catch, and the cord second portion is arranged and designed to releasably attach to the catch,
wherein the plurality of openings in the second upturned end segment are open-ended openings and the cord is arranged and designed to secure the plurality of fishing rods in the open-ended openings of the second upturned end segment when the cord second portion is attached to the catch.

11. The rack apparatus of claim 10, further comprising:
a rack handle connected to the base segment, the rack handle arranged and designed for transporting the rack apparatus; and
at least one fastener for releasably securing the elongate member to a surface of a boat.

12. The rack apparatus of claim 11, wherein the base segment includes an aperture arranged and designed for hanging the elongate member in a substantially vertical position, the aperture being closer to the second upturned end segment than to the first upturned end segment.

13. A rack apparatus for holding at least four fishing rods, each fishing rod having an elongate rod with a handle and a tip portion, and a reel, the rack apparatus comprising:
an elongate member having a base segment and first and second upturned end segments, the first upturned end segment having a plurality of open-ended slots, the second upturned end segment having a plurality of openings, the number of open-ended slots being the same as the number of openings,
wherein the plurality of openings are arranged and designed to receive the rod tip portion and the plurality of open-ended slots are arranged and designed to receive the rod handle;
at least one strap arranged and designed to circumvent the at least four fishing rods and releasably secure the at least four fishing rods to the elongate member;
a rack handle connected to the base segment, the rack handle arranged and designed for transporting the rack apparatus; and
at least one fastener for releasably securing the elongate member to a surface of a boat.

14. The rack apparatus of claim 13, wherein the elongate member includes an aperture on a central longitudinal axis of the base segment, the aperture arranged and designed for hanging the elongate member in a substantially vertical position such that the second upturned end segment is vertically above the first upturned end segment, the aperture being closer to the second upturned end segment than to the first upturned end segment.

15. The rack apparatus of claim 14, wherein the plurality of open-ended slots and the plurality of openings have peripheral edges covered with an elastomeric or rubber material.

16. The rack apparatus of claim 1, wherein the first upturned end segment has first and second side edges, at least two open-ended slots are along the first side edge and at least two open-ended slots are along the second side edge, the at least two open-ended slots along each side edge are positioned in vertical relationship, and
a first strap of the pair of straps is connected to the first upturned end segment below the lower of the at least two open-ended slots along the first side edge and a second strap of the pair of straps is connected to the first upturned end segment below the lower of the at least two open-ended slots along the second side edge.

17. The rack apparatus of claim 16, wherein each strap extends through a lower hole in the first upturned end segment and forms a loop, the loop being arranged and designed to be positioned over one of the upwardly extending teats.

18. The rack apparatus of claim 17, wherein each strap has elasticity such that the looped strap is stretched to extend over the upwardly extending teat.

19. A multi-purpose rod rack apparatus accommodating a plurality of fishing rods, each fishing rod having an elongate rod with a handle and a tip portion, and a reel, the rack apparatus comprising:
an elongate member having a base segment and first and second upturned end segments, the first upturned end segment having a plurality of open-ended slots, the second upturned end segment having a plurality of open-ended slots, the number of open-ended slots at the second upturned end segment being the same as the number of open-ended slots at the first upturned end segment,
wherein the plurality of open-ended slots in the first upturned end segment are arranged and designed to receive the rod handle and the plurality of open-ended slots in the second upturned end segment are arranged and designed to receive the tip portion;
a first strap attached to the first upturned end segment, the first strap arranged and designed to releasably secure two fishing rod handles within two open-ended slots in the first upturned end segment;
a cord attached to the second upturned end segment, the cord arranged and designed to releasably secure at least two tip portions within two open-ended slots in the second upturned end segment; and
at least one fastener for releasably securing the elongate member to a surface of a boat.

20. The rack apparatus of claim 19, further comprising a rack handle connected to the base segment, the rack handle arranged and designed for transporting the rack apparatus with the base segment in a substantially horizontal orientation.

21. The rack apparatus of claim 19, wherein the cord is arranged and designed to releasably secure at least four tip portions within four open-ended slots in the second upturned end segment.

22. The rack apparatus of claim 21, further comprising a second strap attached to the first upturned end segment, the second strap arranged and designed to releasably secure two additional fishing rod handles within two additional open-ended slots in the first upturned end segment.
